(19) United States
(12) Patent Application Publication
(10) Pub. No.: US 2014/0089690 A1
(43) Pub. Date: Mar. 27, 2014

(54) CONTROLLING POWER SUPPLY IN ARITHMETIC PROCESSING CIRCUIT

(71) Applicant: FUJITSU LIMITED, Kawasaki-shi (JP)

(72) Inventor: Takatoshi FUKUDA, Sagamihara (JP)

(73) Assignee: FUJITSU LIMITED, Kawasaki-shi (JP)

(21) Appl. No.: 13/960,854

(22) Filed: Aug. 7, 2013

(30) Foreign Application Priority Data
Sep. 25, 2012 (JP) 2012-211471

(51) Int. Cl. G06F 1/26

(52) U.S. Cl. CPC G06F 1/26
USPC 713/300

(57) ABSTRACT

An arithmetic processing circuit includes a plurality of arithmetic processing units, a plurality of selector circuits each configured to select one of a plurality of power supplies that are fewer than the arithmetic processing units and to connect the selected power supply to a corresponding one of the arithmetic processing units, and a power supply control circuit configured to variably control an output voltage of at least one of the plurality of power supplies.

### CROSS-REFERENCE TO RELATED APPLICATIONS

The present application is based upon and claims the benefit of priority from the prior Japanese Patent Application No. 2012-211471 filed on Sep. 25, 2012, with the Japanese Patent Office, the entire contents of which are incorporated herein by reference.

### FIELD

The disclosures herein relate to an arithmetic processing circuit and a method of controlling power supply in the arithmetic processing circuit.

### BACKGROUND

Dynamic voltage frequency scaling is a technology for reducing power consumption in CPUs (Central Processing Units). In this technology, clock frequency and power supply voltage supplied to a CPU are lowered to reduce power consumption when the utilization rate of the CPU is low. Such a technology is also effective for a multi-core processor in which a plurality of CPU cores are integrated. A straightforward configuration may change power supply voltages to all the cores at the same time. In order to achieve more diligent control for lower power consumption, power supply lines may be provided separately for respective CPU cores. DC-DC converters placed in these power supply lines are used to set voltages, thereby providing different voltages to the CPU cores, respectively (see Patent Document 1, for example). In this configuration, however, both the power supply lines and the DC-DC converters are provided as many as the number of CPU cores, which makes it difficult to satisfy the demand for device size reduction.

Without being limited to CPU application, a technology for controlling power supply in general may supply power supply voltages selected from a plurality of power supplies to a plurality of circuit blocks for power reduction purposes (see Patent Documents 2 and 3, for example). In this method, the high-voltage power supply may need to have a current supply capacity commensurate with the demand when all the circuit blocks request the high voltage. The low-voltage power supply may also need to have a current supply capacity commensurate with the demand when all the circuit blocks request the low voltage. Namely, the power supply circuits are redundant, which hampers the effort to reduce device size.

In order to optimize power supply in response to load conditions, a main power supply system and an auxiliary power supply system may be combined, and the auxiliary power supply may be configured to be connectable to the main power supply and to produce variable output voltage, thereby coping with changes in the load currents (see Patent Document 4, for example). In this method, the output voltage of the main power supply is fixed, and is supplied to fixed destinations. Because of such a configuration, reduction in the number of devices requesting high voltage does not guarantee a commensurate amount of power reduction in the main power supply.
[Patent Document 1] Japanese Laid-open Patent Publication No. 2002-99433
[Patent Document 2] Japanese Laid-open Patent Publication No. 2004-111659
[Patent Document 3] Japanese Laid-open Patent Publication No. 2007-19445
[Patent Document 4] Japanese Laid-open Patent Publication No. 2009-232520

### SUMMARY

According to an aspect of the embodiment, an arithmetic processing circuit includes a plurality of arithmetic processing units, a plurality of selector circuits each configured to select one of a plurality of power supplies that are fewer than the arithmetic processing units and to connect the selected power supply to a corresponding one of the arithmetic processing units, and a power supply control circuit configured to variably control an output voltage of at least one of the plurality of power supplies.

A method of controlling power supply in an arithmetic processing circuit includes obtaining a utilization rate and an operation mode of each of a plurality of arithmetic processing units, determining a next operation mode of each of the plurality of arithmetic processing units in response to the obtained utilization rate and the obtained operation mode, controlling a variable output voltage of at least one of a plurality of power supplies that are fewer than the arithmetic processing circuits, in response to the determined next operation mode, selecting at least one of the plurality of arithmetic processing apparatus in response to the determined next operation mode, and causing a selector circuit corresponding to the selected one of the plurality of arithmetic processing circuits to select one of a plurality of power supply voltages from the plurality of power supplies in response to the determined next operation mode of the selected one of the plurality of arithmetic processing circuits, and supplying the selected one of the plurality of power supply voltages to the selected one of the plurality of arithmetic processing circuits.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1A is a drawing illustrating an example of the configuration of a system of an arithmetic processing apparatus;

FIGS. 1B and 1C are a flowchart illustrating an example of the operation of the system of the arithmetic processing apparatus;

FIG. 2 is a table illustrating an example of power supply control performed when the two operation modes, i.e., a maximum performance mode and a standby mode, are used;

FIG. 3 is a drawing illustrating an example of the configuration of an arithmetic processing apparatus when the number of power supply circuits is 3 and the number of CPU core circuits is 15;

FIG. 4 is a table illustrating an example of power supply control performed by the arithmetic processing apparatus illustrated in FIG. 3;

FIG. 5 is a drawing illustrating an example of the configuration of an arithmetic processing apparatus when the number of power supply circuits is 2 and the number of CPU core circuits is 16;

FIG. 6 is a table illustrating an example of power supply control performed by the arithmetic processing apparatus illustrated in FIG. 5;

FIG. 7 is a drawing illustrating an example of the configuration of an arithmetic processing apparatus that performs power supply control and clock control;

FIG. 8 is a table illustrating an example of power supply control and clock control performed in the arithmetic processing apparatus illustrated in FIG. 7;

FIG. 9 is a drawing illustrating an example of a configuration in which a power supply voltage can be blocked; and

FIG. 10 is a table illustrating advantages of the disclosed configuration.

### DESCRIPTION OF EMBODIMENTS

In the following, embodiments of the invention will be described with reference to the accompanying drawings.

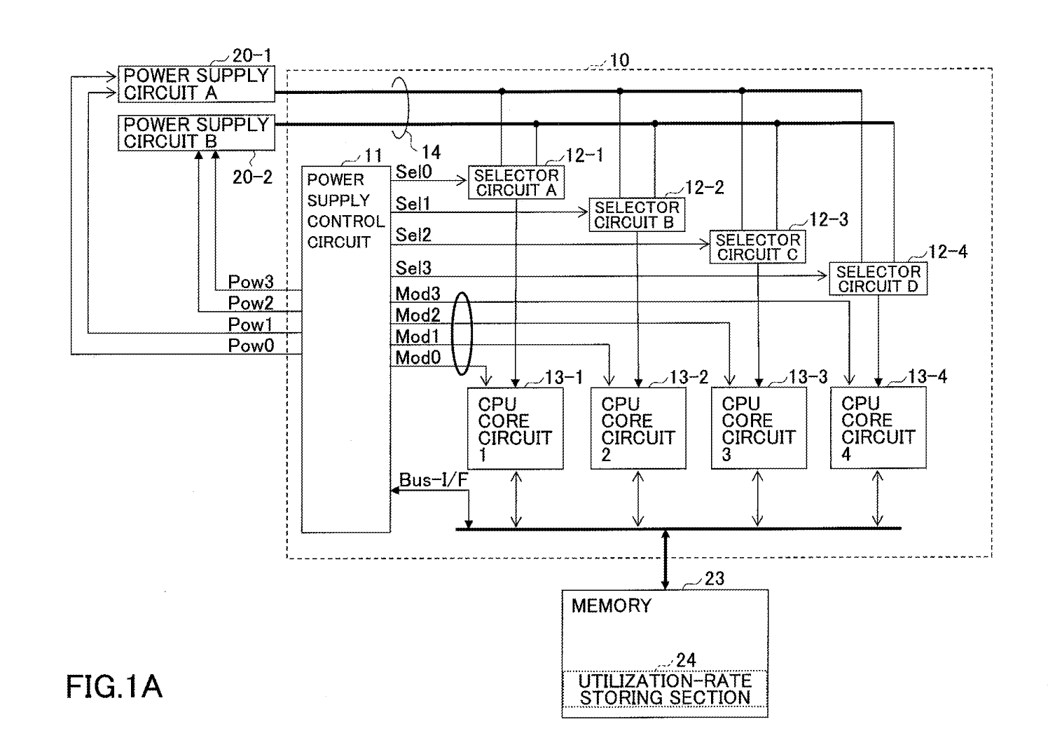

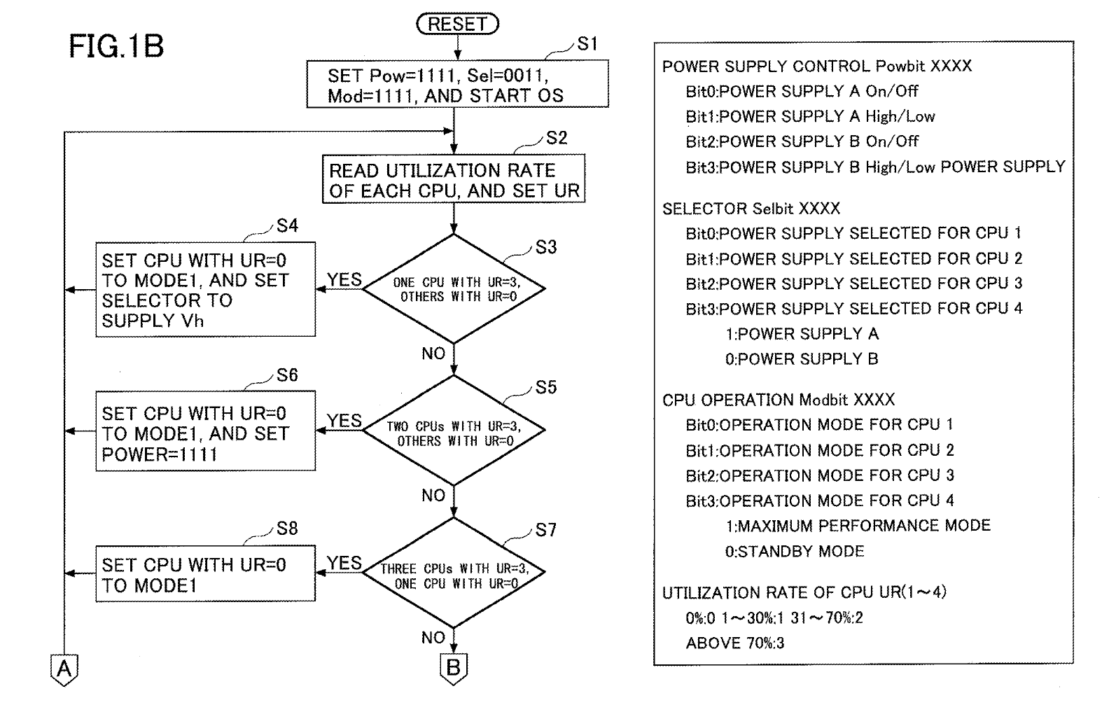

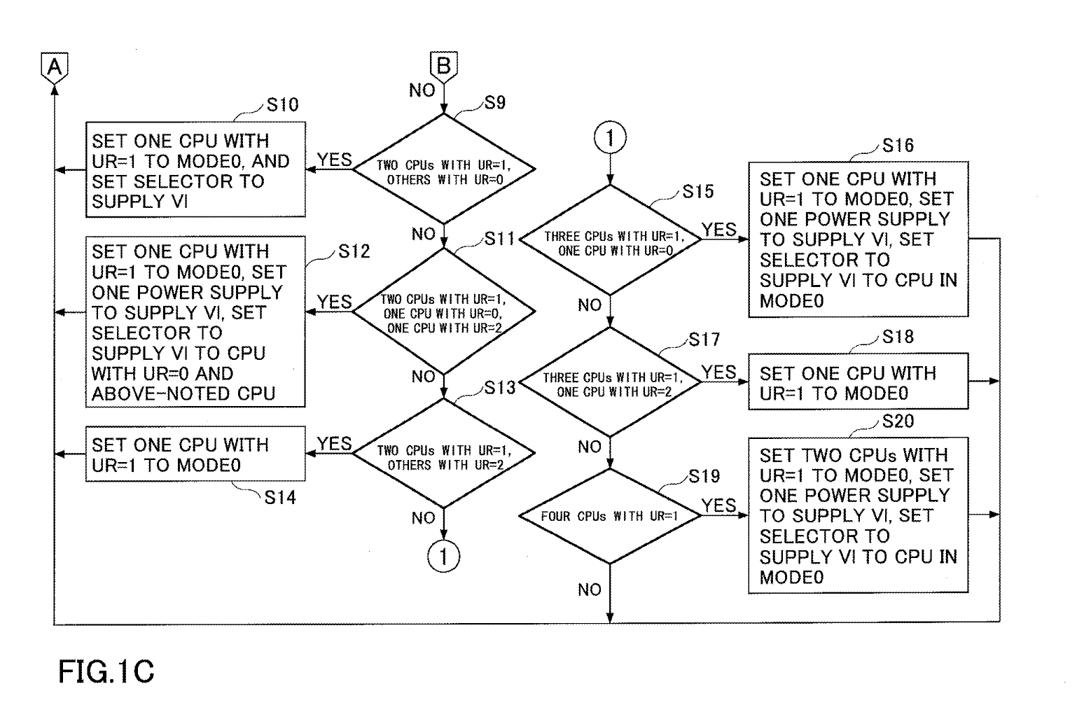

FIG. 1A is a drawing illustrating an example of the configuration of an arithmetic processing apparatus. An arithmetic processing apparatus 10 illustrated in FIG. 1A is connected to power supply circuits 20-1 and 20-2 and to a memory 23. The arithmetic processing apparatus 10 that is a multi-core processor includes a power supply control circuit 11, selector circuits 12-1 through 12-4, CPU core circuits 13-1 through 13-4, and a plurality of power supply lines 14. In this example, the number of the CPU core circuits 13-1 through 13-4 serving as arithmetic processing units is equal to four, and the number of the power supply circuits 20-1 and 20-2 is equal to 2. In the arithmetic processing apparatus 10, it suffices for the number of the power supply circuits 20-1 and 20-2 to be smaller than the number of the CPU core circuits 13-1 through 13-4. As long as this condition is satisfied, these numbers are not limited to particular numbers. The power supply lines 14 supply power from the power supply circuits 20-1 and 20-2 that are fewer than the CPU core circuits 13-1 through 13-4. Accordingly, the number of the power supply lines 14 is smaller than the number of the CPU core circuits 13-1 through 13-4.

In the example illustrated in FIG. 1A, the output voltage of the power supply circuit 20-1 is fixed, and the output voltage of the power supply circuit 20-2 is variable. The power supply control circuit 11 controls the variable output voltage of at least one power supply (i.e., the power supply circuit 20-2 in this example) among the plurality of power supplies, i.e., can set at least two output voltages that are not 0 V. For example, the output voltage of the power supply circuit 20-1 is fixed to a high voltage (e.g., 1.0 V), and the output voltage of the power supply circuit 20-2 is variably set to either the high voltage (i.e., 1.0 V) or a low voltage (e.g., 0.6 V). Further, the power supply control circuit 11 may control the on-or-off state (i.e., activated-or-inactivated state) of the power supply circuits 20-1 and 20-2.

The selector circuits 12-1 through 12-4 receive power supply voltages from the power supply circuits 20-1 and 20-2 that are fewer than the CPU core circuits 13-1 through 13-4. The selector circuits 12-1 through 12-4 select one of the power supply voltages supplied from the power supply circuits 20-1 and 20-2, and supply (i.e., apply) the selected voltage to the CPU core circuits 13-1 through 13-4, respectively. Which one of the power supply voltage is selected by the selector circuits 12-1 through 12-4 is controlled by control signals supplied from the power supply control circuit 11.

If the selector circuits were not provided, and only the output of the power supply circuit 20-2 serving as a variable-output-voltage power supply was supplied to all the CPU core circuits 13-1 through 13-4, there would be only two operation modes, i.e., one in which all the CPU core circuits operated with the high voltage and the other in which all the CPU core circuits operated with the low voltage. Such a configuration could not achieve an operation mode in which some CPU core circuits operate with the high voltage while the other CPU core circuits operate with the low voltage. Even with the provision of selector circuits, if the output voltages of the power supply circuits 20-1 and 20-2 were fixed to the high voltage and the low voltage, respectively, the power supply circuit 20-1 would be required to have a power supply capacity (i.e., current supply capacity) commensurate with the demand when all the CPU core circuits operate with the high voltage. Namely, when all the CPU core circuits 13-1 through 13-4 operated with the high voltage, the power supply circuit 20-1 would be required to have a power supply capacity (i.e., current supply capacity) that was sufficient to drive these four CPU core circuits.

With the provision of the selector circuits 12-1 through 12-4 as in the configuration illustrated in FIG. 1A, an operation mode in which some CPU core circuits operate with the high voltage while the other CPU core circuits operate with the low voltage is provided, thereby achieving efficient reduction in power consumption. Further, with the variable output voltage of the power supply circuit 20-2, it suffices for the total power supply capacity of the power supply circuits 20-1 and 20-2 to be able to drive the four CPU core circuits even when all the four CPU core circuits 13-1 through 13-4 operate with the high voltage. In this manner, the provision of the selector circuits 12-1 through 12-4 and the variable nature of the output voltage of the power supply circuit 20-2 can provide an efficient circuit configuration having no redundancy in power supply circuits while being able to operate desired CPU core circuits with the low voltage, thereby achieving efficient reduction in power consumption.

In the example illustrated in FIG. 1A, the selector circuits 12-1 through 12-4 are provided in one-to-one correspondence with the CPU core circuits 13-1 through 13-4, respectively. It may be noted, however, that selector circuits do not have to be provided for all the CPU core circuits. Namely, one or more selector circuits may select one of the power supply voltages supplied from the power supply circuits 20-1 and 20-2, and may supply (i.e., apply) the selected voltage to at least one of the CPU core circuits 13-1 through 13-4. For example, the configuration may be such that the selector circuits 12-1 through 12-3 are provided while the selector circuit 12-4 is not provided, with the CPU core circuit 13-4 operating with the power supplied from the power supply circuit 20-1 all the time. In another example, the configuration may be such that the selector circuit 12-1 is provided while the selector circuits 12-2 through 12-4 are not provided, with the CPU core circuits 13-2 through 13-4 operating with the power supplied from the power supply circuit 20-1 all the time. Such a difference in configurations merely affects the degree to which power consumption is reduced. Namely, the provision of a selector circuit for at least one CPU core circuit makes it possible to control power supply voltage applied to this CPU core circuit, thereby achieving reduction in power consumption. The larger the proportion of the CPU core circuits for which selector circuits are provided, the higher the effect of reduction in power consumption is.

The arithmetic processing apparatus 10 operates with the power supply voltages supplied from the power supply circuits 20-1 and 20-2 to perform a desired arithmetic operation. The arithmetic processing apparatus 10 accesses the memory 23 according to need, thereby reading, from the memory 23, a program to be executed by the arithmetic processing apparatus 10 and data to be processed in the arithmetic operation, and writing to the memory 23 data obtained as a result of the arithmetic operation. The memory 23 includes a utilization-rate storing section 24. The utilization-rate storing section 24 stores therein the respective utilization rates of the CPU core circuits 13-1 through 13-4. The CPU core circuits 13-1 through 13-4 may detect the utilization rates, and may write the detected utilization rates to the utilization-rate storing section 24. The CPU core circuits 13-1 through 13-4 may execute an OS (i.e., operating system) in a shared manner to constitute an SMP (i.e., symmetric multiprocessor). In such a case, the OS may detect the utilization rates of the respective CPU core circuits, and may write the detected utilization rates to the utilization-rate storing section 24. The utilization rate may be detected as a ratio of the first period during which an application is running on a CPU core circuit of interest to the sum of the first period and the second period during which the application is waiting. In a predetermined period, the proportion of the time during which an application is running may be 30%, and the proportion of the time during which the application is waiting may be 70%. In such a case, the utilization rate may be 30%. The writing of utilization rates may be performed at constant intervals.

The power supply control circuit 11 reads the utilization rates of the CPU core circuits 13-1 through 13-4 from the memory 23, and controls (e.g., changes) the variable output voltage of the power supply circuit 20-2 in response to the utilization rates and operation modes of the CPU core circuits 13-1 through 13-4. The power supply control circuit 11 also controls the selector circuits 12-1 through 12-4 in response to the utilization rates and operation modes of the CPU core circuits 13-1 through 13-4, thereby causing the selector circuits 12-1 through 12-4 to select one of the power supply voltages supplied from the power supply circuits 20-1 and 20-2. The power supply control circuit 11 also sets the operation modes in the CPU core circuits 13-1 through 13-4 where the operation modes are either a maximum performance mode or a standby mode. These control operations by the power supply control circuit 11 are performed through close communication with the OS such that the settings are made valid during the ongoing operation of the OS on each CPU.

More specifically, the power supply control circuit 11 selects respective operation modes to be used next in the CPU core circuits 13-1 through 13-4 in response to the respective utilization rates of the CPU core circuits 13-1 through 13-4. In response to the selected next operation modes, the power supply control circuit 11 controls (e.g., changes) the output voltage of at least one (i.e., the power supply circuit 20-2 in this example) of the power supply circuits 20-1 and 20-2 that are fewer than the CPU core circuits 13-1 through 13-4. The power supply control circuit 11 also controls the selector circuits 12-1 through 12-4 in response to the selected next operation modes, thereby causing the selector circuits 12-1 through 12-4 to select one of the power supply voltages supplied from the power supply circuits 20-1 and 20-2 and to supply (i.e., apply) the selected voltage to the CPU core circuits 13-1 through 13-4.

More specifically, the power supply control circuit 11 produces four power supply control signals Pow0 through Pow3. Pow0 serves to control the on-or-off state of a power supply A. Pow0 assumes 1 to select the “on” state, and assumes 0 to select the “off” state. Pow1 serves to control the output voltage of the power supply A. Pow1 assumes 1 to select the high voltage, and assumes 0 to select the low voltage. Pow2 serves to control the on-or-off state of a power supply B. Pow2 assumes 1 to select the “on” state, and assumes 0 to select the “off” state. Pow3 serves to control the output voltage of the power supply B. Pow3 assumes 1 to select the high voltage, and assumes 0 to select the low voltage.

There are four power-supply-select control signals Sel0 through Sel3. Sel0 serves to select the power supply that is supplied to CPU1. Sel0 assumes to select the power supply A, and assumes 0 to select the power supply B. Sel1 serves to select the power supply that is supplied to CPU2. Sel2 serves to select the power supply that is supplied to CPU3. Sel3 serves to select the power supply that is supplied to CPU4.

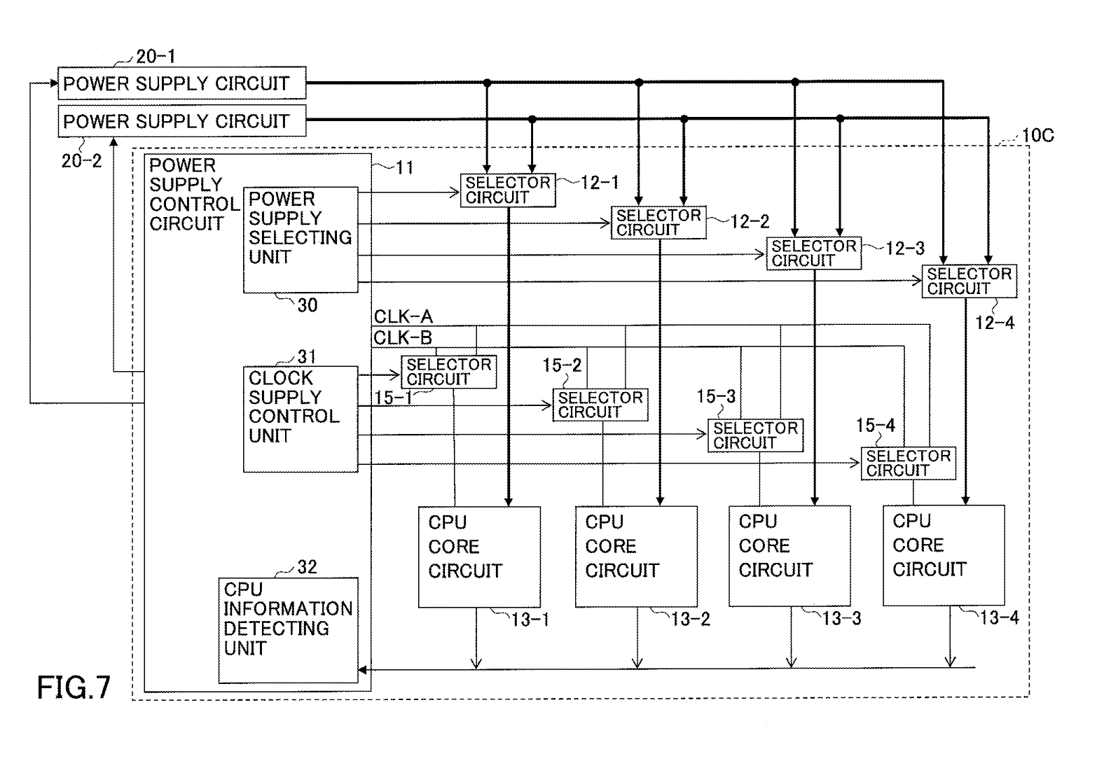

There are four CPU-operation-mode setting signals Mod0 through Mod3. Mod0 serves to set the operation mode of CPU1. Mod0 assumes 1 to select the maximum performance mode, and assumes 0 to select the standby mode. Mod1 serves to set the operation mode of CPU2. Mod2 serves to set the operation mode of CPU3. Mod3 serves to set the operation mode of CPU4. These CPU-operation-mode setting signals may be used to select clock signals that are supplied to the respective CPUs. Signals output from a clock supply control unit illustrated in FIG. 7 are examples of such signals.

There is an interface signal Bus-I/F for reading data from the memory 23. The operation of the power supply control circuit 11 will be described with reference to the flowchart illustrated in FIGS. 1B and 1C.

Upon resetting the apparatus, in step S1, Pow is set equal to 1111, thereby setting the two power supplies to the “on” state and setting their output voltages to the high voltage. Further, Sel is set equal to 0011, thereby connecting CPU1 and CPU2 to the power supply A and connecting CPU3 and CPU4 to the power supply B. Moreover, Mod is set equal to 1111, thereby setting all the CPUs to the high performance mode.

After the OS starts, in step S2, the power supply control circuit 11 reads the utilization-rate storing section 24 of the memory 23 by use of the interface signal Bus-IF in order to obtain information about the utilization rates of the respective CPUs. It is assumed that the OS has already written the utilization rates of the respective CPUs to the utilization-rate storing section 24.

In step S2, also, UR of each CPU is determined based on the read data. UR is set to 0 in the case of the utilization rate being 0%, 1 in the case of the utilization rate being in a range of 1% to 30%, 2 in the case of the utilization rate being in a range of 31% to 70%, and 3 in the case of the utilization rate exceeding 70%. UR is set to 0 only when the utilization rate of a CPU is 0%, i.e., only when the CPU is in the standby state.

In step S3, a check is made as to whether there is only one CPU having a UR that is 3, with the remaining CPUs being in the standby state having URs that are 0. If the answer is affirmative, this one CPU is running in a state close to the maximum utilization rate. In this case, in step S4, the selector is set such as to supply the high voltage to one of the remaining CPUs, and the operation mode is set to the high performance mode with respect to this CPU, so that this CPU can operate immediately. At this time, one of the power supplies is supposed to be supplying the high voltage while the other is supplying the low voltage. No new setting is thus made to the power supply voltages. It may be noted that if one or more of the CPUs having URs that are not 3 has a UR that is 1 or 2, these one or more CPUs have available power to deal with a load increase. No action is taken in such a case.

In step S5, a check is made as to whether there are two CPUs having URs that are 3, with the remaining CPUs being in the standby state having URs that are 0. If the answer is affirmative, these two CPUs are running in a state close to the maximum utilization rate. In this case, in step S6, the two power supplies are set such that both supply the high voltages, and the operation mode is set to the high performance mode with respect to one of the remaining CPUs, so that this one of the remaining CPUs can operate immediately. It may be noted that if one or more of the CPUs having URs that are not 3 has a UR that is 1 or 2, these one or more CPUs have available power to deal with a load increase. No action is taken in such a case.

In step S7, a check is made as to whether there are three CPUs having URs that are 3, with the remaining CPU being in the standby state having a UR that is 0. If the answer is affirmative, these three CPUs are running in a state close to the maximum utilization rate. In this case, in step S8, the operation mode is set to the high performance mode with respect to the one remaining CPU, so that this remaining CPU can operate immediately. At this time, both of the power supplies are supposed to be outputting the high voltage. No power supply control is thus performed.

In steps S9, S11, and S13, a check is made as to whether there are two CPUs having URs that are 1. An affirmative answer indicates that there are two CPUs for which the utilization rates are 30% or less. In this case, in steps S10, S12, and S14, one of these two CPUs is placed in the operation mode “0” that is the standby mode. When there is a power supply that is supplying the low voltage, a selector setting is made such that the above-noted CPU is connected to this power supply. When there is no power supply that is supplying the low voltage, and there is no CPU in the operation mode “0” that is the standby mode, all that is performed is to place in the standby mode one of the two CPUs having URs that are 1. If there is a CPU in the operation mode “0”, one of the two CPUs having URs that are 1 is placed in the standby mode, and a selector setting is made such that this CPU receives power from the same power supply that supplies power to the CPU having been in the standby mode, followed by setting the output of this power supply to the low voltage.

In steps S15 and S17, a check is made as to whether there are three CPUs having URs that are 1. An affirmative answer indicates that there are three CPUs for which the utilization rates are 30% or less. In this case, in steps S16 and S18, one of these two CPUs is placed in the operation mode “0” that is the standby mode. If the one remaining CPU has a UR that is zero indicative of the standby mode, one of the CPUs having URs that are 1 is placed in the standby mode, and a selector setting is made such that this CPU receives power from the same power supply that supplies power to the CPU having been in the standby state, followed by setting the output of this power supply to the low voltage. If the one remaining CPU has a UR that is not zero, all that is performed is to place in the standby mode one of the two CPUs having URs that are 1.

In step S19, a check is made as to whether there are four CPUs having URs that are 1. An affirmative answer indicates that there are four CPUs for which the utilization rates are 30% or less. In this case, in step S20, two of these four CPUs are placed in the operation mode “0” that is the standby mode. Further, selector settings are made such that these two CPUs receive power from the same power supply, followed by setting the output of this power supply to the low voltage. After these steps are completed, the procedure returns to step S2.

The operation modes of the CPU core circuits 13-1 through 13-4 may include the maximum performance mode, the low performance mode, and the standby mode. With the provision of these three operation modes, the output voltage of the power supply circuit 20-2 may be variably set to one of a high voltage (e.g., 1.0 V), a middle voltage (e.g., 0.8 V), and a low voltage (e.g., 0.6 V). In the maximum performance mode, a CPU core circuit operates with the high voltage (e.g., 1.0 V) to consume a large electric power (e.g., 10 W). In the low performance mode, a CPU core circuit operates with the middle voltage (e.g., 0.8 V) to consume a mid-level electric power (e.g., 1 W). In the standby mode, a CPU core circuit operates with the low voltage (e.g., 0.6 V) to consume a low electric power (e.g., 0.1 W). In the standby mode, each device of the CPU circuit may not make a transition in response to a clock signal while the power supply voltage is consumed to keep data stored in memory elements (i.e., registers) such as SRAM (static random access memory) elements, for example.

FIG. 1A illustrates the configuration for power supply control, and does not illustrate the configuration for clock control. As will be described later with reference to FIG. 7, the frequencies of clock signals supplied to the CPU core circuits 13-1 through 13-4, respectively, may be changed depending on the operation mode. For example, in the maximum performance mode, a CPU core circuit may operate with a high-speed clock (e.g., 1 GHz) and with the high voltage (e.g., 1.0 V) to consume a large electric power (e.g., 10 W). In the low performance mode, a CPU core circuit may operate with a middle-speed clock (e.g., 500 MHz) and with the middle voltage (e.g., 0.8 V) to consume a mid-level electric power (e.g., 1 W). In the standby mode, a CPU core circuit receives no clock signal, and may operate with the low voltage (e.g., 0.6 V) to consume a low electric power (e.g., 0.1 W). Clock control will be described in conjunction with a description of the arithmetic processing apparatus illustrated in FIG. 7.

In FIG. 1A, the following algorithm may be used as a method of selecting operation modes to be used next in the respective CPU core circuits 13-1 through 13-4 in response to the respective utilization rates and current operation modes of the CPU core circuits 13-1 through 13-4. The utilization rate of a CPU core circuit is denoted as Ract. A CPU core circuit in the maximum performance mode may make a transition to the low performance mode in response to Ract falling below 20%. A CPU core circuit in the low performance mode may make a transition to the standby mode in response to the passage of a predetermined time length during which Ract stays at 0%. A CPU core circuit in the low performance mode may also make a transition to the maximum performance mode in response to Ract exceeding above 60%. A CPU core circuit in the standby mode makes a transition to the maximum performance mode in response to the occurrence of a new job request when the three other CPU core circuits are in the maximum performance mode and Ract is larger than or equal to 80%.

The description given above has been directed to an example in which there are three operation modes, i.e., the maximum performance mode, the low performance mode, and the standby mode. This is not a limiting example, and the number of operation modes is not limited to three. For example, the configuration may be such that there are only two operation modes, i.e., the maximum performance mode and the standby mode.

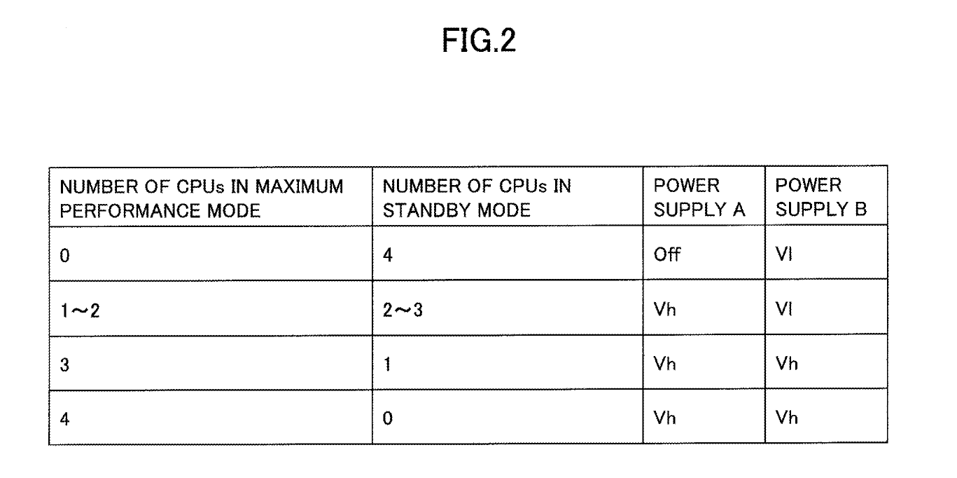

FIG. 2 is a table illustrating an example of power supply control performed when the two operation modes, i.e., the maximum performance mode and the standby mode, are used. In FIG. 2, a power supply A refers to the power supply circuit 20-1, and a power supply B refers to the power supply circuit 20-2. Vh denotes the high voltage (e.g., 1.0 V), and Vl denotes the low voltage (e.g., 0.6 V) There are four CPU core circuits 13-1 through 13-4. Each power supply has a current supply capacity sufficient to drive two CPU core circuits in the maximum performance mode.

When no CPU core circuit is in the maximum performance mode, and four CPU core circuits are in the standby mode, the output voltage of the power supply A is set to 0 V (i.e., the power supply is powered off), and the output voltage of the power supply B is set to Vl. The output voltage Vl of the power supply B is supplied to the four CPU core circuits through selector circuits. When one to two CPU core circuits are in the maximum performance mode, and three to two CPU core circuits are in the standby mode, the output voltage of the power supply A is set to Vh, and the output voltage of the power supply B is set to Vl. The output voltage Vh of the power supply A is supplied through selector circuits to the CPU core circuits in the maximum performance mode, and the output voltage Vl of the power supply B is supplied through selector circuits to the CPU core circuits in the standby mode.

When three CPU core circuits are in the maximum performance mode, and one CPU core circuit is in the standby mode, the output voltage of the power supply A is set to Vh, and the output voltage of the power supply B is also set to Vh. The output voltage Vh of the power supply A is supplied through selector circuits to the two CPU core circuits in the maximum performance mode, and the output voltage Vh of the power supply B is supplied through selector circuits to the CPU core circuit in the maximum performance mode and to the CPU core circuit in the standby mode. In this case, the power supply voltage of the CPU core circuit in the standby mode is Vh. Despite this, an increase in power consumption is relatively small because the operation mode is the standby mode. When four CPU core circuits are in the maximum performance mode, and no CPU core circuit is in the standby mode, the output voltage of the power supply A is set to Vh, and the output voltage of the power supply B is also set to Vh. The output voltage Vh of the power supply A is supplied through selector circuits to the two CPU core circuits in the maximum performance mode, and the output voltage Vh of the power supply B is supplied through selector circuits to the two CPU core circuits in the maximum performance mode.

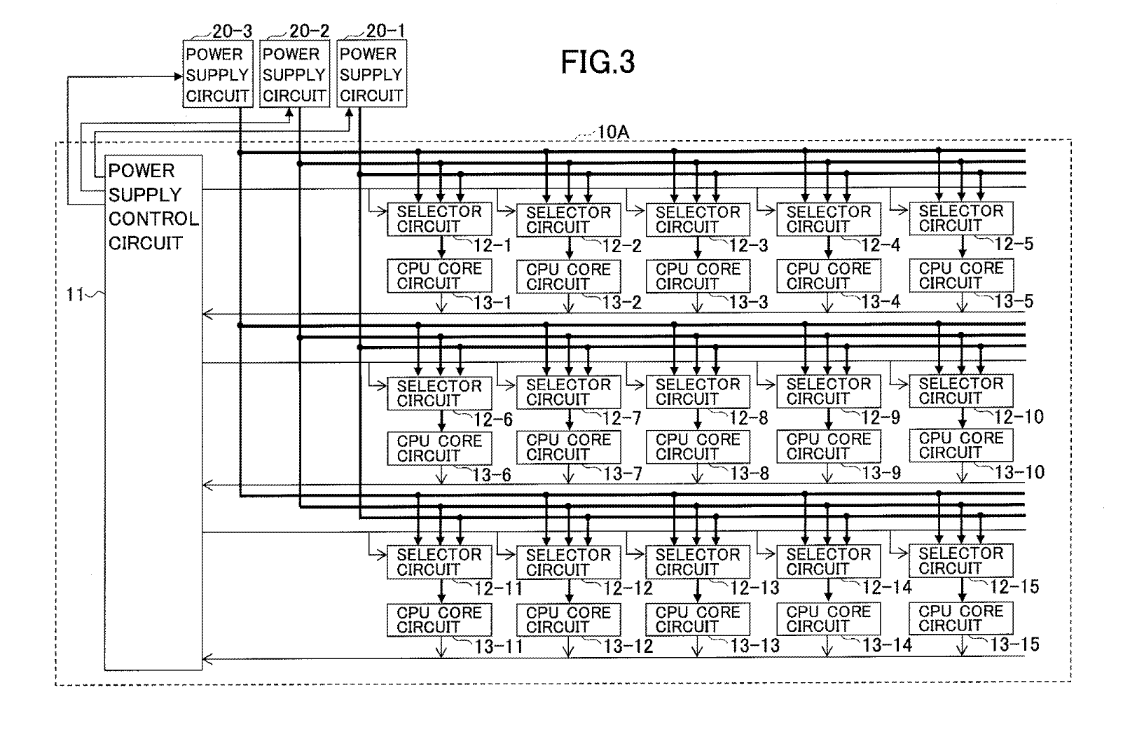

FIG. 3 is a drawing illustrating an example of the configuration of an arithmetic processing apparatus when the number of power supply circuits is 3 and the number of CPU core circuits is 15. In FIG. 3, the same or corresponding elements as those of FIG. 1 are referred to by the same or corresponding numerals, and a description thereof will be omitted as appropriate. Further, although an arithmetic processing apparatus 10A is connected to a memory as in the configuration illustrated in FIG. 1, such a memory is omitted from illustration in FIG. 3.

The arithmetic processing apparatus 10A includes a power supply control circuit 11, selector circuits 12-1 through 12-15, and CPU core circuits 13-1 through 13-15. The output voltage of the power supply circuit 20-1 is fixed, and the output voltages of the power supply circuits 20-2 and 20-3 are variable. Each of the CPU core circuits 13-1 through 13-15 operates in one of the three operation modes, i.e., the maximum performance mode, the low performance mode, and the standby mode.

The power supply control circuit 11 controls the variable output voltages of the power supply circuits 20-2 and 20-3, i.e., can set at least two output voltages that are not 0 V. The output voltage of the power supply circuit 20-1 is fixed to the high voltage Vh (e.g., 1.0 V). The output voltage of the power supply circuit 20-2 is variably set equal to one of the high voltage Vh (1.0 V) and the middle voltage Vm (e.g., 0.8 V). The output voltage of the power supply circuit 20-3 is variably set equal to one of the high voltage Vh (1.0 V), the middle voltage Vm (e.g., 0.8 V), and the low voltage Vl (e.g., 0.6 V). Further, the power supply control circuit 11 may control the on-or-off state (i.e., activated-or-inactivated state) of the power supply circuits 20-1 through 20-3.

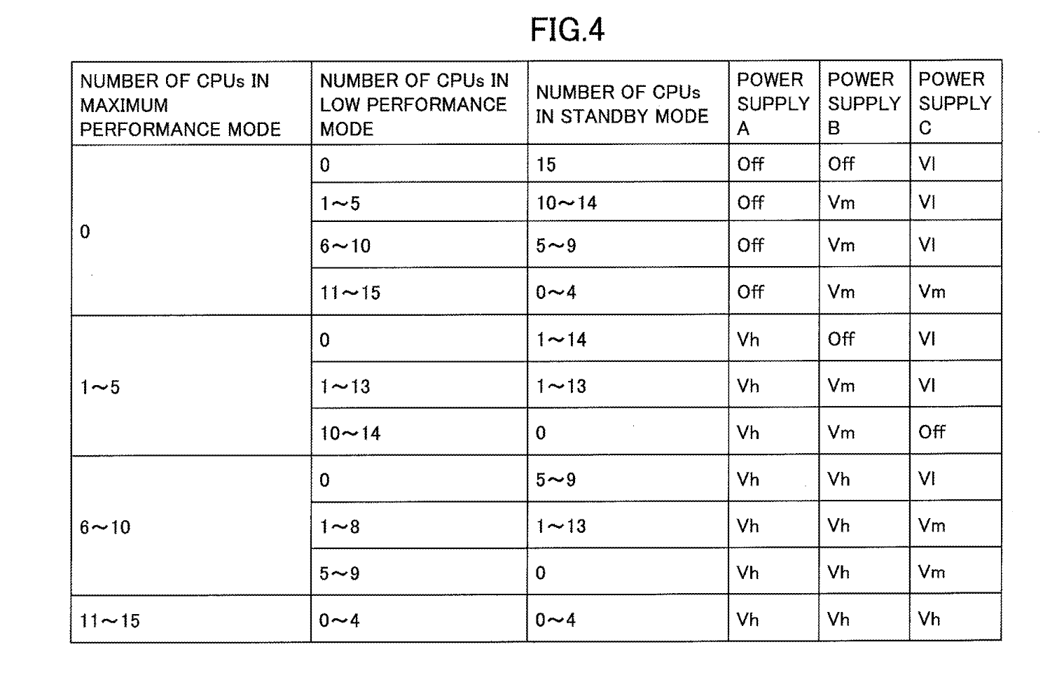

FIG. 4 is a table illustrating an example of power supply control performed by the arithmetic processing apparatus illustrated in FIG. 3. A power supply A refers to the power supply circuit 20-1, and a power supply B refers to the power supply circuit 20-2, with a power supply C referring to the power supply circuit 20-3. In this example, it is assumed that the ratio of the currents consumed by respective CPU core circuits in the maximum performance mode, the low performance mode, and the standby mode are 15:5:1. Each power supply has a current supply capacity sufficient to supply an amount of current that is five times the amount of current consumed by one CPU core circuit operating in the maximum performance mode. Namely, one power supply circuit can drive five CPU core circuits operating in the maximum performance mode. Further, one power supply circuit can drive fifteen CPU core circuits operating in the low performance mode. Moreover, one power supply circuit can drive seventy five CPU core circuits operating in the standby mode.

In this case, it suffices for each of the three power supplies A through C to supply (i.e., apply) the high voltage Vh to five CPU core circuits when all the CPU core circuits 13-1 through 13-15 are in the maximum performance mode. When there are ten CPU core circuits operating in the maximum performance mode, three CPU core circuits operating in the low performance mode, and two CPU core circuits operating in the standby mode, for example, it suffices for the power supplies A and B to output the high voltage Vh and for the power supply C to output the middle voltage Vm. In this case, it suffices for each of the power supplies A and B to supply (i.e., apply) the high voltage Vh to five CPU core circuits operating in the maximum performance mode, and it suffices for the power supply C to supply the middle voltage Vm to the CPU core circuits operating in the low performance mode and to the CPU core circuits operating in the standby mode.

When there are one CPU core circuit operating in the maximum performance mode, no CPU core circuit operating in the low performance mode, and fourteen CPU core circuits operating in the standby mode, for example, it suffices for the power supply A to output the high voltage Vh, for the power supply B to be powered off, and for the power supply C to output the low voltage Vl. In this case, it suffices for the power supply A to supply the high voltage Vh to the one CPU core circuit operating in the maximum performance mode, and it suffices for the power supply C to supply the low voltage Vl to the fourteen CPU core circuits operating in the standby mode. When there are no CPU core circuit operating in the maximum performance mode, ten CPU core circuits operating in the low performance mode, and five CPU core circuits operating in the standby mode, for example, it suffices for the power supply A to be powered off, for the power supply B to supply the middle voltage Vm, and for the power supply C to output the low voltage Vl. In this case, it suffices for the power supply B to supply the middle voltage Vm to the ten CPU core circuits operating in the low performance mode, and it suffices for the power supply C to supply the low voltage Vl to the five CPU core circuits operating in the standby mode.

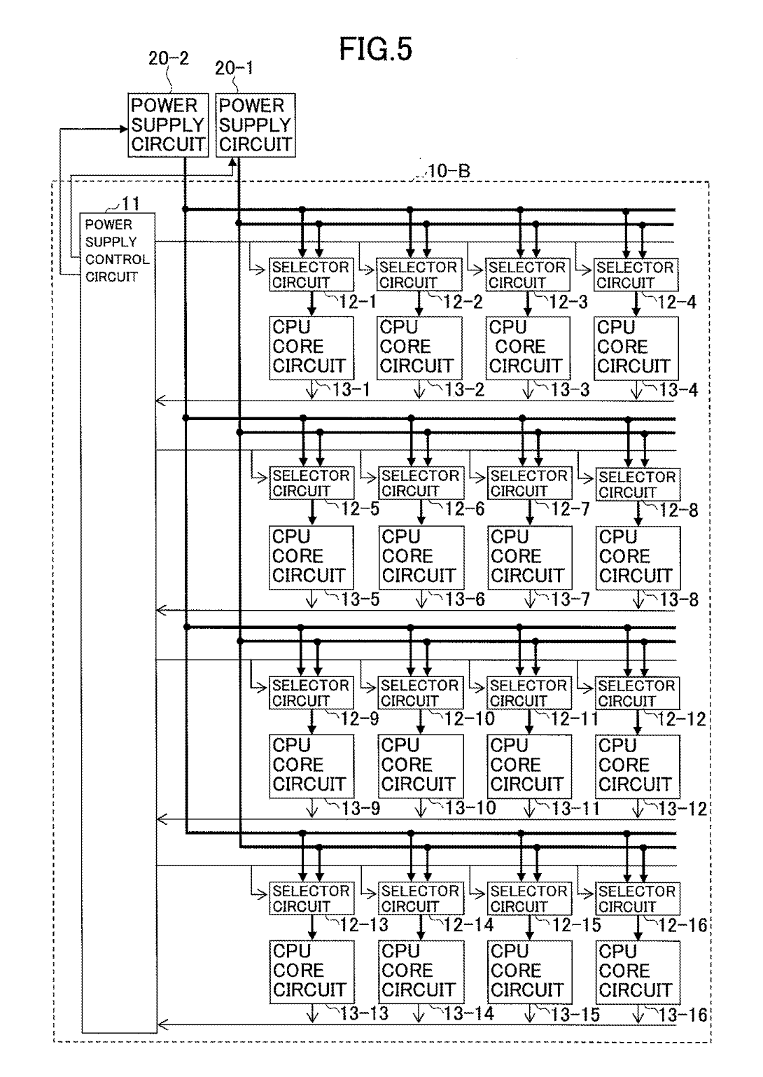

FIG. 5 is a drawing illustrating an example of the configuration of an arithmetic processing apparatus when the number of power supply circuits is 2 and the number of CPU core circuits is 16. In FIG. 5, the same or corresponding elements as those of FIG. 1A are referred to by the same or corresponding numerals, and a description thereof will be omitted as appropriate. Further, although an arithmetic processing apparatus 10B is connected to a memory as in the configuration illustrated in FIG. 1A, such a memory is omitted from illustration in FIG. 5.

The arithmetic processing apparatus 10B includes a power supply control circuit 11, selector circuits 12-1 through 12-16, and CPU core circuits 13-1 through 13-16. The output voltage of the power supply circuit 20-1 is fixed, and the output voltage of the power supply circuit 20-2 is variable. Each of the CPU core circuits 13-1 through 13-16 operates in one of the three operation modes, i.e., the maximum performance mode, the low performance mode, and the standby mode.

The power supply control circuit 11 controls the variable output voltage of the power supply circuit 20-2, i.e., can set at least two output voltages that are not 0 V. The output voltage of the power supply circuit 20-1 is fixed to the high voltage Vh (e.g., 1.0 V). The output voltage of the power supply circuit 20-2 is variably set equal to one of the high voltage Vh (1.0 V) and the middle voltage Vm (e.g., 0.8 V). Further, the power supply control circuit 11 may control the on-or-off state (i.e., activated-or-inactivated state) of the power supply circuits 20-1 and 20-2.

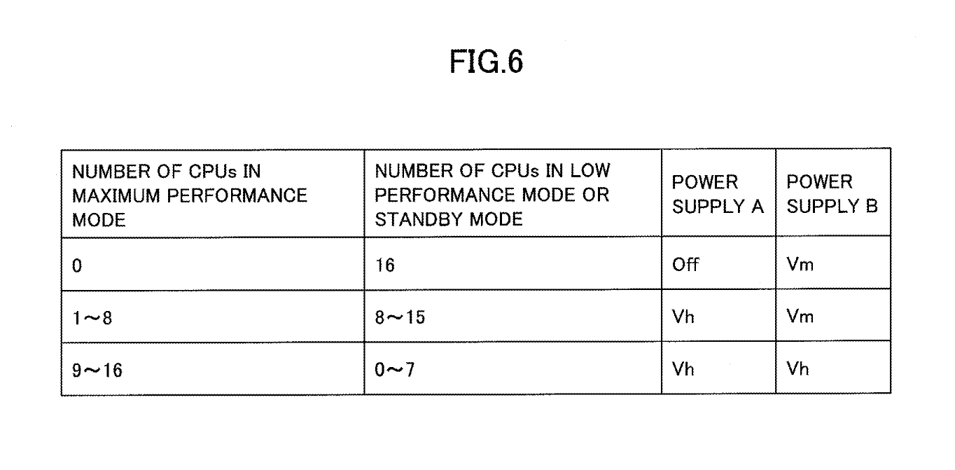

FIG. 6 is a table illustrating an example of power supply control performed by the arithmetic processing apparatus illustrated in FIG. 5. A power supply A refers to the power supply circuit 20-1, and a power supply B refers to the power supply circuit 20-2. In this example, it is assumed that the ratio of the currents consumed by respective CPU core circuits in the maximum performance mode, the low performance mode, and the standby mode are 15:5:1. Each power supply has a current supply capacity sufficient to supply an amount of current that is eight times the amount of current consumed by one CPU core circuit operating in the maximum performance mode. Namely, one power supply circuit can drive eight CPU core circuits operating in the maximum performance mode. Further, one power supply circuit can drive twenty four CPU core circuits operating in the low performance mode. Moreover, one power supply circuit can drive one hundred twenty CPU core circuits operating in the standby mode.

In this case, it suffices for each of the two power supplies A and B to supply (i.e., apply) the high voltage Vh to eight CPU core circuits when all the CPU core circuits 13-1 through 13-16 are in the maximum performance mode, for example. When there are no CPU core circuit operating in the maximum performance mode and sixteen CPU core circuits operating in the low performance mode or in the standby mode, for example, it suffices for the power supply A to be powered off and for the power supply B to supply the middle voltage Vm. In this case, only the power supply B is active to drive all the CPU core circuits operating in the low performance mode or in the standby mode.

FIG. 7 is a drawing illustrating a configuration in which the CPU-operation-mode setting signals in FIG. 1A are used to select clock signals that are supplied to the respective CPUs. In this example, power supply control and clock control are performed with respect to the arithmetic processing apparatus. In FIG. 7, the same or corresponding elements as those of FIG. 1A are referred to by the same or corresponding numerals, and a description thereof will be omitted as appropriate. Further, although an arithmetic processing apparatus 10C is connected to a memory as in the configuration illustrated in FIG. 1A, such a memory is omitted from illustration in FIG. 7.

The arithmetic processing apparatus 10C includes a power supply control circuit 11, selector circuits 12-1 through 12-4, CPU core circuits 13-1 through 13-4, and selector circuits 15-1 through 15-4. The output voltage of the power supply circuit 20-1 is fixed, and the output voltage of the power supply circuit 20-2 is variable. Each of the CPU core circuits 13-1 through 13-4 operates in one of the two operation modes, i.e., the maximum performance mode and the standby mode.

The power supply control circuit 11 controls the variable output voltage of the power supply circuit 20-2, i.e., can set at least two output voltages that are not 0 V. The output voltage of the power supply circuit 20-1 is fixed to the high voltage Vh (e.g., 1.0 V). The output voltage of the power supply circuit 20-2 is variably set equal to one of the high voltage Vh (1.0 V) and the low voltage Vl (e.g., 0.6 V). Further, the power supply control circuit 11 may control the on-or-off state (i.e., activated-or-inactivated state) of the power supply circuits 20-1 and 20-2.

The selector circuits 15-1 through 15-4 receive a plurality of different clocks signals CLK-A and CLK-B. The selector circuits 15-1 through 15-4 select one of the clock signals CLK-A and CLK-B, and supply (i.e., apply) the selected clock signal to the CPU core circuits 13-1 through 13-4, respectively. Which one of the clock signals is selected by the selector circuits 15-1 through 15-4 is controlled by control signals supplied from the power supply control circuit 11. The power supply control circuit 11 includes a power supply selecting unit 30 for controlling the selector circuits 12-1 through 12-4, a clock supply control unit 31 for controlling the selector circuits 15-1 through 15-4, and a CPU information detecting unit 32 for acquiring the utilization rate and operation state (i.e., mode) of each CPU.

There is a close relationship between operating voltage and operating frequency in a circuit that utilizes CMOS devices. The higher the operating voltage, the higher the operating frequency can be. Further, power consumption is proportional to the square of power supply voltage, and increases in proportion to operating frequency. In the configuration illustrated in FIG. 7, the power supply to a CPU core circuit is lowered, and, also, the frequency of a clock signal supplied to the CPU core circuit is lowered when maximum performance is not required.

An OS (i.e., operating system) running on each of the CPUs in a shared manner controls in which mode each CPU operates. Further, the OS gets hold of information about the utilization rate of each CPU. Based on such information, the CPU information detecting unit determines a voltage and a clock signal for each CPU.

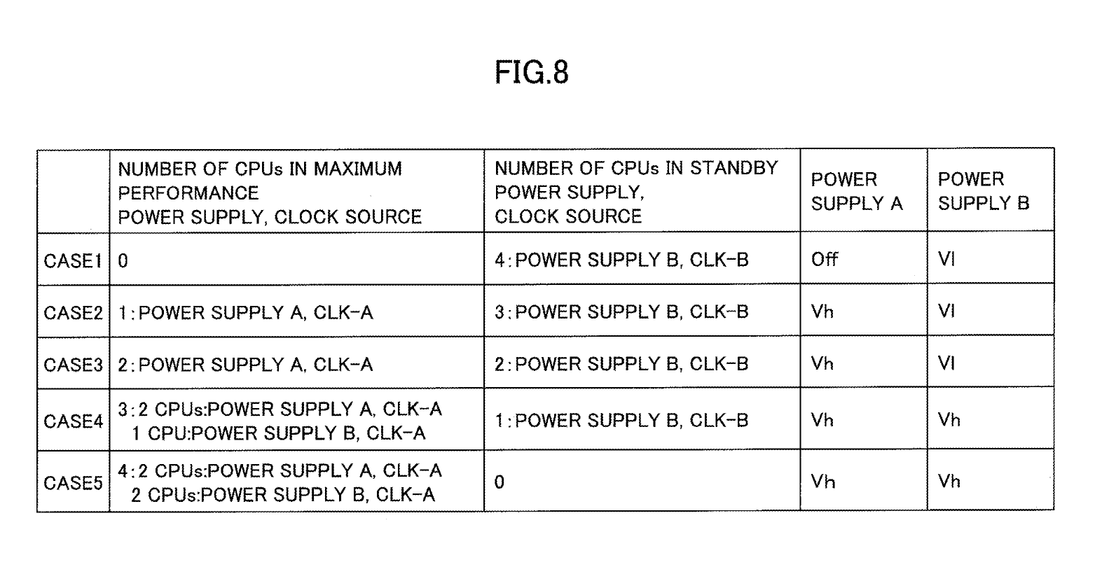

FIG. 8 is a table illustrating an example of power supply control and clock control performed in each CPU operation mode in the arithmetic processing apparatus illustrated in FIG. 7. Power supply control is the same as or similar to the control performed as illustrated in FIG. 2. A clock signal CLK-A is a high frequency clock signal used in the maximum performance mode, and a clock signal CLK-B is a low frequency clock signal used in the standby mode. In the standby mode, most of a CPU core circuit does not use a clock signal. Nonetheless, a clock signal is supplied in the present embodiment in order to return from the standby mode.

In FIG. 8, when no CPU core circuit is in the maximum performance mode, and four CPU core circuits are in the standby mode, the power supply A is turned off, and the output voltage of the power supply B is set to the low voltage Vl. The four CPU core circuits in the standby mode receive the voltage Vl from the power supply B. These four CPU core circuits in the standby mode receive the low-speed clock signal CLK-B. This is illustrated in the table as CASE1.

When one CPU core circuit is in the maximum performance mode, and three CPU core circuits are in the standby mode, the output voltage of the power supply A is set to the high voltage Vh, and the output voltage of the power supply B is set to the low voltage Vl. The one CPU core circuit in the maximum performance mode receives the voltage Vh from the power supply A, and receives the high-speed clock signal CLK-A. The three CPU core circuits in the standby mode receives the voltage Vl from the power supply B, and receives the low-speed clock signal CLK-B. This is illustrated in the table as CASE2.

When two CPU core circuits are in the maximum performance mode, and two CPU core circuits are in the standby mode, the output voltage of the power supply A is set to the high voltage Vh, and the output voltage of the power supply B is set to the low voltage Vl. The two CPU core circuits in the maximum performance mode receive the voltage Vh from the power supply A, and receive the high-speed clock signal CLK-A. The two CPU core circuits in the standby mode receive the voltage Vl from the power supply B, and receive the low-speed clock signal CLK-B. This is illustrated in the table as CASE3.

When three CPU core circuits are in the maximum performance mode, and one CPU core circuit is in the standby mode, the output voltage of the power supply A is set to the high voltage Vh, and the output voltage of the power supply B is also set to the high voltage Vh. Two of the three CPU core circuits in the maximum performance mode receive the voltage Vh from the power supply A, and receive the high-speed clock signal CLK-A. The remaining one of the three CPU core circuits in the maximum performance mode receives the voltage Vh from the power supply B, and receives the high-speed clock signal CLK-A. The one CPU core circuit in the standby mode receives the voltage Vh from the power supply B, and receives the low-speed clock signal CLK-B. This CPU core circuit in the standby mode receives the high voltage Vh as an operating voltage. Since the clock signal is slow, however, power consumption can be reduced to some degree. This is illustrated in the table as CASE4.

When four CPU core circuits are in the maximum performance mode, and no CPU core circuit is in the standby mode, the output voltage of the power supply A is set to the high voltage Vh, and the output voltage of the power supply B is also set to the high voltage Vh. Two of the four CPU core circuits in the maximum performance mode receive the voltage Vh from the power supply A, and receive the high-speed clock signal CLK-A. The remaining two of the four CPU core circuits in the maximum performance mode receive the voltage Vh from the power supply B, and receives the high-speed clock signal CLK-A. This is illustrated in the table as CASE5.

In the following, a description will be given of how a transition is made from one of CASE1 through CASE5 to another one of CASE1 through CASE5. As was previously described, the OS gets hold of the utilization rate of each CPU, and causes each CPU to shift from the maximum performance mode to the standby mode or from the standby mode to the maximum performance mode. Specifically, a transition is made in the same or similar manner as the one described in connection with FIGS. 1B and 1C. The OS determines UR based on the detected utilization rate of each CPU, and then determines the operation mode of each CPU based on the determined UR. In FIGS. 1B and 1C, the power supply control unit determines operation modes whereas in the present embodiment, the OS determines operation modes. The OS informs the CPU information detecting unit 32 of the operation mode of each CPU. The power supply control unit then selects a voltage to be produced by each power supply, a power supply to be supplied to each CPU, and a clock signal to be supplied to each CPU.

In the example described above, the low-speed clock signal CLK-B is supplied to CPU core circuits in the standby mode. This is not a limiting example, and the configuration of the apparatus may be such that neither the clock signal CLK-A nor the clock signal CLK-B is supplied to the CPU core circuits in the standby mode. Such a configuration can make a further reduction in power consumption.

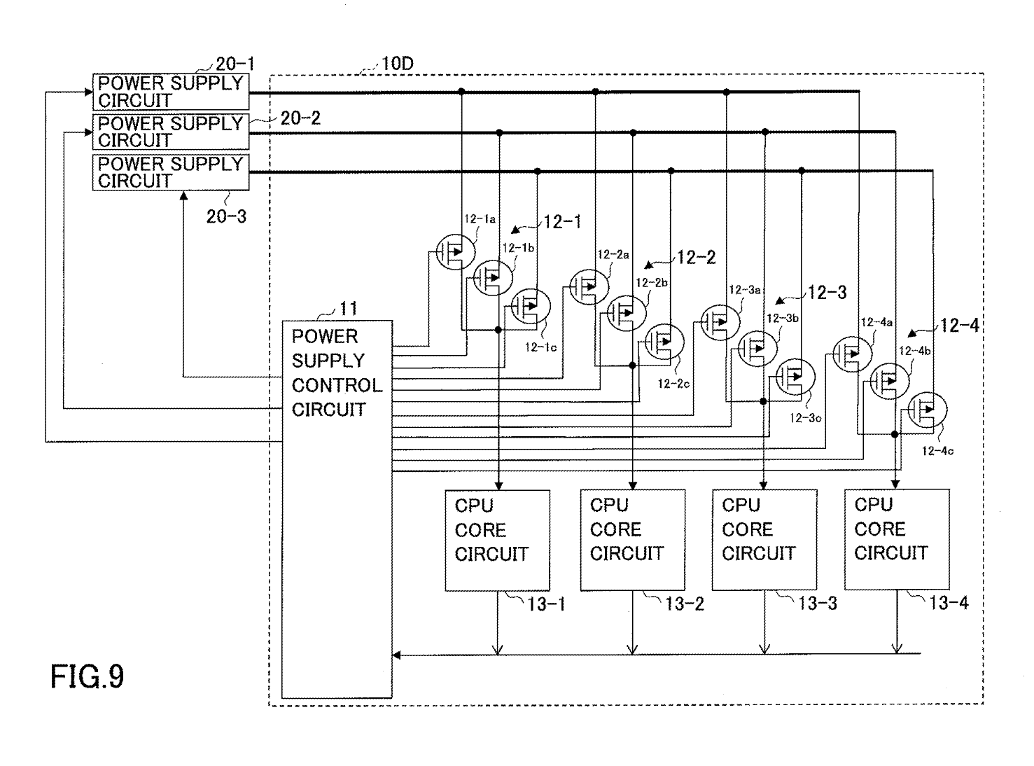

FIG. 9 is a drawing illustrating an example of the configuration in which a power supply voltage can be blocked. In FIG. 9, the same or corresponding elements as those of FIG. 1A are referred to by the same or corresponding numerals, and a description thereof will be omitted as appropriate. Further, although an arithmetic processing apparatus 10D is connected to a memory as in the configuration illustrated in FIG. 1A, such a memory is omitted from illustration in FIG. 9.

The arithmetic processing apparatus 10D includes a power supply control circuit 11, selector circuits 12-1 through 12-4, and CPU core circuits 13-1 through 13-4. The selector circuit 12-1 includes PMOS transistors 12-1a through 12-1c. The selector circuit 12-2 includes PMOS transistors 12-2a through 12-2c. The selector circuit 12-3 includes PMOS transistors 12-3a through 12-3c. The selector circuit 12-4 includes PMOS transistors 12-4a through 12-4c. Control signals from the power supply control circuit 11 are applied to the gates of these PMOS transistors. These control signals serve to control the conductive and nonconductive states of the individual PMOS transistors. In the selector circuit 12-1, for example, one of the PMOS transistors 12-1a through 12-1c is placed in the conductive state, thereby selecting one of the three power supplies to supply the voltage of this selected power supply to the CPU core circuit 13-1.

As is well known, a leak current flows in a CMOS circuit to consume power even when the clock is suspended. In the arithmetic processing apparatus 10D illustrated in FIG. 9, each of the selector circuits 12-1 through 12-4 can select one of the power supply voltages, and also can block all the power supply voltages. With this configuration, the power supply voltage to a CPU core circuit operating in the standby mode can be blocked to eliminate a leak current when there is a CPU core circuit in the standby mode under the condition in which all the power supply circuits supply the high voltage. This can further reduce power consumption.

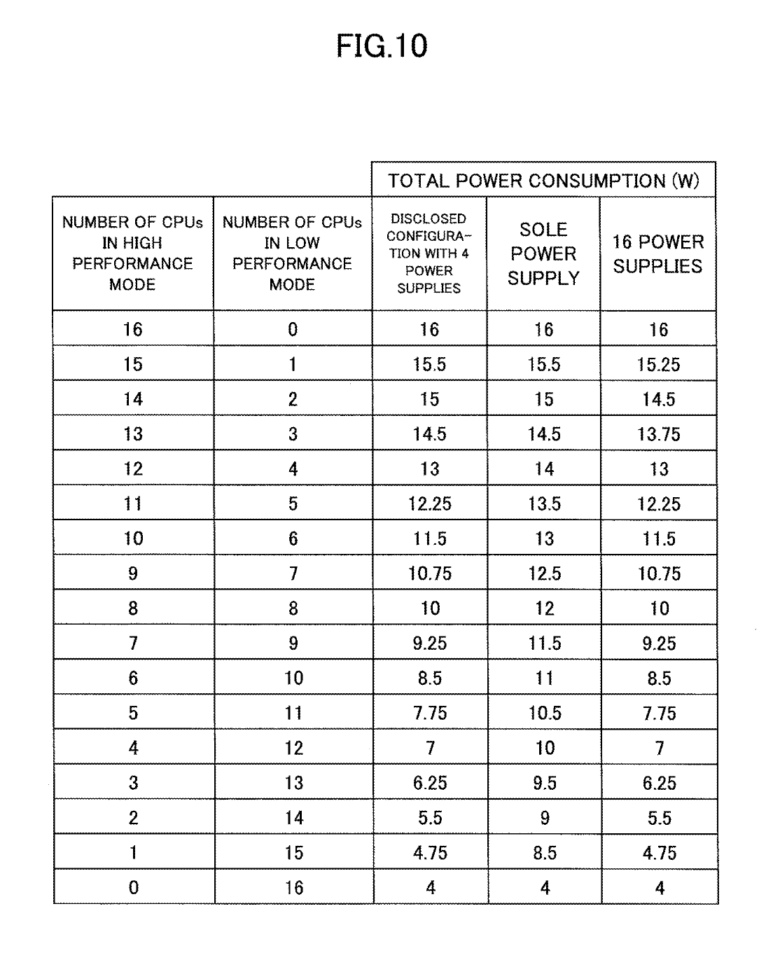

FIG. 10 is a drawing for explaining an advantage of the disclosed configuration by use of a simple example.

The number of CPU cores is 16. Each core operating in the high performance mode consumes 1 W with the power supply voltage that is 1 V. When the operating frequency is halved in the low performance mode, each core consumes 0.25 W with the power supply voltage that is 0.7 V, and consumes 0.5 W with the power supply voltage that is kept at 1.0 V. This example reflects the fact that the power consumption of a CMOS circuit is proportional to the operating frequency and also proportional to the square of the voltage. Comparison will be made between the disclosed configuration with four power supplies, a configuration in which a sole power supply supplies power to all the CPU cores, and a configuration in which power supplies are provided in one-to-one correspondence with the CPU cores to supply power. The table of FIG. 10 is obtained by calculating power consumption while changing the number of CPUs in the high performance mode and the number of CPUs in the low performance mode in the three configurations noted above. In the configuration in which respective power supplies (i.e., 16 power supplies) supply power to CPUs, the voltage can be lowered to 0.7 V on a CPU-core-specific basis when a CPU core of interest is placed in the low performance mode. Because of this, as the number of CPU cores operating in the low performance mode increases, power consumption drops significantly. In the configuration in which a sole power supply supplies power to all the CPU cores, the power supply voltage is set to 1.0 V when there is even one CPU operating in the high performance mode. Because of this, a reduction in power consumption is not so significant when the number of CPUs operating in the low performance mode increases. From the viewpoint of power consumption, the configuration that uses 16 power supplies is superior. The disclosed configuration with the four power supplies can achieve almost the same results as the configuration that uses 16 power supplies.

When manufacturing cost and space are taken into account, the configuration that uses a sole power supply is superior. In this regard, the disclosed configuration is not so much inferior to the configuration that uses a sole power supply. When power consumption is also taken into account, the disclosed configuration is superior to the other configurations.

Further, the present invention is not limited to these embodiments, but various variations and modifications may be made without departing from the scope of the present invention.

According to at least one embodiment, an arithmetic processing circuit is provided that achieves, with power supplies fewer than arithmetic processing units, an efficient reduction in power consumption that is almost as efficient as in the case in which power supplies are provided in one-to-one correspondence with arithmetic processing units.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An arithmetic processing circuit, comprising:
a plurality of arithmetic processing units;
a plurality of selector circuits each configured to select one of a plurality of power supplies that are fewer than the arithmetic processing units and to connect the selected power supply to a corresponding one of the arithmetic processing units; and
a power supply control circuit configured to variably control an output voltage of at least one of the plurality of power supplies.

2. The arithmetic processing circuit as claimed in claim 1, wherein the power supply control circuit is further configured to receive at least one of a utilization rate and an operation mode of at least one of the plurality of arithmetic processing units, and to determine, in response to the received utilization rate and the received operation mode, the output voltage of the at least one of the plurality of power supplies that is variably controlled.

3. The arithmetic processing circuit as claimed in claim 1, wherein the power supply control circuit is further configured to control at least one of the plurality of selector circuits in response to the received utilization rate and the received operation mode, thereby causing the at least one of the plurality of selector circuits to select one of the plurality of power supplies.

4. The arithmetic processing circuit as claimed in claim 1, wherein each of the plurality of selector circuits is configured to set an output voltage thereof equal to zero or to block all power supply voltages from the plurality of power supplies.

5. A method of controlling power supply in an arithmetic processing circuit, comprising:
obtaining a utilization rate and an operation mode of each of a plurality of arithmetic processing units;
determining a next operation mode of each of the plurality of arithmetic processing units in response to the obtained utilization rate and the obtained operation mode;
controlling a variable output voltage of at least one of a plurality of power supplies that are fewer than the arithmetic processing circuits, in response to the determined next operation mode;
selecting at least one of the plurality of arithmetic processing apparatus in response to the determined next operation mode; and
causing a selector circuit corresponding to the selected one of the plurality of arithmetic processing circuits to select one of a plurality of power supply voltages from the plurality of power supplies in response to the determined next operation mode of the selected one of the plurality of arithmetic processing circuits, and supplying the selected one of the plurality of power supply voltages to the selected one of the plurality of arithmetic processing circuits.
